(19) United States
(12) Patent Application Publication
(10) Pub. No.: US 2014/0301885 A1
(43) Pub. Date: Oct. 9, 2014

(54) PERMANENT MAGNET AND METHOD FOR MANUFACTURING PERMANENT MAGNET

(71) Applicant: NITTO DENKO CORPORATION, Ibaraki-shi, Osaka (JP)

(72) Inventors: Keisuke Taihaku, Ibaraki-shi (JP); Takashi Ozaki, Ibaraki-shi (JP); Katsuya Kume, Ibaraki-shi (JP); Toshiaki Okuno, Ibaraki-shi (JP); Izumi Ozeki, Ibaraki-shi (JP); Tomohiro Omure, Ibaraki-shi (JP); Takashi Yamamoto, Ibaraki-shi (JP)

(73) Assignee: NITTO DENKO CORPORATION, Ibaraki-shi, Osaka (JP)

(21) Appl. No.: 14/241,524

(22) PCT Filed: Sep. 25, 2012
(86) PCT No.: PCT/JP2012/074473

§ 371 Date: Feb. 27, 2014

(30) Foreign Application Priority Data
Sep. 30, 2011 (JP) 2011-218596

(51) Int. Cl. H01F 1/08; H01F 41/02

(52) U.S. Cl. CPC H01F 1/086; H01F 41/0266
USPC 419/10; 75/230

(57) ABSTRACT

In a permanent magnet and a manufacturing method thereof, entire magnet can be densely sintered without a gap between a main phase and a grain boundary phase. Fine powder of milled neodymium magnet is mixed with a solution containing an organometallic compound expressed with a structural formula, M-(OR)_{X}, wherein M represents Cu, Al, Dy, Tb, V, Mo, Zr, Ta, Ti, W or Nb, R represents a substituent group consisting of a straight-chain or branched-chain hydrocarbon, and _{X} represents an arbitrary integer, to uniformly adhere the organometallic compound to particle surfaces of the neodymium magnet powder. The magnet powder is desiccated and then held for several hours in hydrogen atmosphere at a pressure higher than normal atmospheric pressure, at 200-900 degrees Celsius for calcination process in hydrogen. The calcined powder after calcination process in hydrogen is held for several hours in vacuum at 200-600 degrees Celsius for dehydrogenation process.

### TECHNICAL FIELD

The present invention relates to a permanent magnet and a manufacturing method of the permanent magnet.

### BACKGROUND ART

In recent years, a decrease in size and weight, an increase in power output and an increase in efficiency have been demanded in a permanent magnet motor used in a hybrid car, a hard disk drive, or the like. A further improvement in magnetic performance is required of a permanent magnet to be buried in the permanent magnet motor, for the purpose of realizing such a decrease in size and weight, an increase in power output and an increase in efficiency in the permanent magnet motor mentioned above. Meanwhile, as permanent magnet, there have been known ferrite magnets, Sm—Co-based magnets, Nd—Fe—B-based magnets, Sm₂Fe₁₇Nₓ-based magnets or the like. As permanent magnet for permanent magnet motor, Nd—Fe—B-based magnets are typically used among them due to remarkably high residual magnetic flux density.

As method for manufacturing a permanent magnet, a powder sintering process is generally used. In this powder sintering process, raw material is coarsely milled first and furthermore, is finely milled into magnet powder by a jet mill (dry-milling) method. Thereafter, the magnet powder is put in a mold and pressed to form in a desired shape with magnetic field applied from outside. Then, the magnet powder formed and solidified in the desired shape is sintered at a predetermined temperature (for instance, at a temperature between 800 and 1150 degrees Celsius for the case of Nd—Fe—B-based magnet) for completion.

### PRIOR ART DOCUMENT

### Patent Document

Patent document 1: Japanese Registered Patent Publication No. 3298219 (pages 4 and 5)

### DISCLOSURE OF THE INVENTION

### Problem to be Solved by the Invention

On the other hand, as to Nd-based magnets such as Nd—Fe—B magnets, poor heat resistance is pointed to as defect. Therefore, in case a Nd-based magnet is employed in a permanent magnet motor, continuous driving of the motor brings the magnet into gradual decline of residual magnetic flux density and irreversible demagnetization. Then, in case of employing a Nd-based magnet in a permanent magnet motor, in order to improve heat resistance of Nd-based magnet, dysprosium (Dy) or terbium (Tb) having high magnetic anisotropy is added in attempt to further improve coercive force.

As method for adding Dy or Tb, there have been conventionally known two methods: a grain boundary diffusion method such that Dy or Tb is made to be put on a surface of a sintered magnet so as to be diffused; and a two-alloys method such that two types of powder corresponding to a main phase and a grain boundary phase are separately prepared and thereafter mixed (dry blending). Those methods have their own defects. The former method is effective for magnets in flat shape or in fragments, but in a form of a large-sized magnet, a diffusion length of Dy or Tb cannot be extended to a grain boundary phase formed inside. In the latter method, magnets are made by blending and pressing the two alloys, which results in diffusion of Dy or Tb in grains and failure to get Dy or Tb concentrated in grain boundaries.

Further, Dy or Tb is rare metal and producing regions are limited. It is therefore preferable to curtail even small amount of Dy or Tb to be used with respect to that of Nd. Furthermore, as problem, addition of large amount of Dy or Tb lowers residual magnetic flux density which represents magnet intensity. Thus, there has been desired art to efficiently concentrate traces of Dy or Tb in grain boundaries so as to significantly improve coercive force of a magnet without decline of residual magnetic flux density.

Further, it would be practicable to add Dy or Tb in a state of an organometallic compound, to a Nd-based magnet so as to concentrate Dy or Tb in grain boundaries of the magnet. Generally speaking, however, once an organometallic compound is added to a magnet, carbon-containing substances remain in the magnet even if the organic solvent is later volatilized by vacuum drying or the like. Since neodymium (Nd) and carbon exhibit significantly high reactivity therebetween, the carbon-containing substances form carbide when remaining up to high-temperature stage in a sintering process. Consequently, the carbide thus formed makes a gap between a main phase and a grain boundary phase of the sintered magnet and accordingly the entirety of the magnet cannot be sintered densely, which causes a problem of serious degradation in the magnetic performance. Even if the gap is not made, the secondarily-formed carbide makes alpha iron separated out in the main phase of the sintered magnet, which causes a problem of serious degradation in the magnetic properties.

Further, aluminum (Al) or copper (Cu), or a high melting point metal element such as vanadium (V) or niobium (Nb) has been added to the magnet powder, besides the above mentioned Dy or Tb, in order to improve magnetic properties of the permanent magnet. However, addition of such a metal element in a state of organometallic compound will likely allow carbon-containing substances to remain in the magnet in a similar manner, which also causes a problem of serious degradation in the magnetic properties.

The invention has been made in order to solve the above-mentioned conventional problems, and an object of the invention is to provide a permanent magnet in which the magnet powder mixed with the organometallic compound is calcined in a hydrogen atmosphere at a pressure higher than normal atmospheric pressure before sintering so that the amount of carbon contained in a magnet particle can be reduced in advance, enabling the entirety of the magnet to be densely sintered without making a gap between a main phase and a grain boundary phase in the sintered magnet.

### Means for Solving the Problem

To achieve the above object, the present invention provides a permanent magnet manufactured through steps of: milling magnet material into magnet powder; adding an organometallic compound expressed with a structural formula of M-(OR)_{X}, M representing Cu, Al, Dy, Tb, V, Mo, Zr, Ta, Ti, W or Nb, R representing a substituent group consisting of a straight-chain or branched-chain hydrocarbon, and _{X} representing an arbitrary integer, to the magnet powder obtained at the step of milling magnet material and getting the organometallic compound adhered to particle surfaces of the magnet powder; calcining the magnet powder of which particle surfaces have got adhesion of the organometallic compound in hydrogen atmosphere at a pressure higher than normal atmospheric pressure so as to obtain calcined powder; forming the calcined powder into a formed body; and sintering the formed body.

In the above-described permanent magnet of the present invention, metal contained in the organometallic compound is concentrated in grain boundaries of the permanent magnet after sintering.

In the above-described permanent magnet of the present invention, R in the structural formula is an alkyl group.

In the above-described permanent magnet of the present invention, R in the structural formula is an alkyl group of which carbon number is anyone of integer numbers 2 through 6.

In the above-described permanent magnet of the present invention, residual carbon content after sintering is 600 ppm or lower.

In the above-described permanent magnet of the present invention, in the step of calcining the magnet powder, the magnet powder is held for predetermined length of time within a temperature range between 200 and 900 degrees Celsius.

To achieve the above object, the present invention further provides a manufacturing method of a permanent magnet comprising steps of milling magnet material into magnet powder; adding an organometallic compound expressed with a structural formula of M-(OR)_{X}, M representing Cu, Al, Dy, Tb, V, Mo, Zr, Ta, Ti, W or Nb, R representing a substituent group consisting of a straight-chain or branched-chain hydrocarbon, and _{X} representing an arbitrary integer, to the magnet powder obtained at the step of milling magnet material and getting the organometallic compound adhered to particle surfaces of the magnet powder; calcining the magnet powder of which particle surfaces have got adhesion of the organometallic compound in hydrogen atmosphere at a pressure higher than normal atmospheric pressure so as to obtain calcined powder; forming the calcined powder into a formed body; and sintering the formed body.

In the above-described manufacturing method of permanent magnet of the present invention, R in the structural formula is an alkyl group.

In the above-described manufacturing method of permanent magnet of the present invention, R in the structural formula is an alkyl group of which carbon number is any one of integer numbers 2 through 6.

In the above-described manufacturing method of permanent magnet of the present invention, in the step of calcining the magnet powder, the magnet powder is held for predetermined length of time within a temperature range between 200 and 900 degrees Celsius.

### Effect of the Invention

According to the permanent magnet of the present invention, Cu, Al, Dy, Tb, V, Mo, Zr, Ta, Ti, W, or Nb contained in the organometallic compound can be efficiently concentrated in grain boundaries of the magnet. As a result, magnetic properties of the permanent magnet can be improved. Furthermore, as the additive amount of Cu, Al, Dy, Tb, V, Mo, Zr, Ta, Ti, W, or Nb can be made smaller than that in a conventional method, the residual magnetic flux density can be inhibited from lowering. Further, by calcining the magnet including organometallic compound in hydrogen atmosphere at a pressure higher than normal atmospheric pressure before sintering, carbon content contained in magnet particles can be reduced previously. Consequently, the entirety of the magnet can be sintered densely without making a gap between a main phase and a grain boundary phase in the sintered magnet, and decline of coercive force can be avoided. Further, considerable alpha iron does not separate out in the main phase of the sintered magnet and serious deterioration of magnetic properties can be avoided.

Further, since powdery magnet particles are calcined, thermal decomposition of the organometallic compound contained can be caused more easily in the entirety of the magnet particles in comparison with the case of calcining formed magnet particles. In other words, carbon content in the calcined powder can be reduced more reliably.

According to the permanent magnet of the present invention, if V, Mo, Zr, Ta, Ti, W, or Nb, each of which is a refractory metal, is concentrated in grain boundaries of the magnet after sintering, V, Mo, Zr, Ta, Ti, W, or Nb concentrated at the grain boundaries prevents grain growth in the magnet particles at sintering, and at the same time disrupts exchange interaction among the magnet particles after sintering so as to prevent magnetization reversal in the magnet particles, making it possible to improve the magnetic performance thereof.

Further, if Dy or Tb having high magnetic anisotropy is concentrated at grain boundaries of the sintered magnet, a reverse magnetic domain can be prevented from generating in the grain boundaries by the Dy or Tb concentrated at the grain boundaries, and improvement of coercive force can be realized.

Further, if Cu or Al is concentrated at the grain boundaries in a magnet, a rare-earth rich phase can be dispersed uniformly and improvement of coercive force can be realized.

According to the permanent magnet of the present invention, the organometallic compound consisting of an alkyl group is used as organometallic compound to be added to magnet powder. Therefore, thermal decomposition of the organometallic compound can be caused easily when the magnet powder is calcined in hydrogen atmosphere. Consequently, carbon content in the calcined powder can be reduced more reliably.

According to the permanent magnet of the present invention, the organometallic compound consisting of an alkyl group of which carbon number is any one of integer numbers 2 through 6 is used as organometallic compound to be added to magnet powder. Therefore, the organometallic compound can be thermally decomposed at lower temperature when the magnet powder is calcined in hydrogen atmosphere. Consequently, thermal decomposition of the organometallic compound can be caused more easily in the entirety of the magnet powder. In other words, carbon content in the calcined powder can be reduced more reliably through a calcination process.

According to the permanent magnet of the present invention, the residual carbon content after sintering is 600 ppm or lower. This configuration avoids occurrence of a gap between a main phase and a grain boundary phase, places the entirety of the magnet in densely-sintered state and makes it possible to avoid decline in residual magnetic flux density. Further, this configuration prevents considerable alpha iron from separating out in the main phase of the sintered magnet so that serious deterioration of magnetic properties can be avoided.

According to the permanent magnet of the present invention, in the step of calcining the magnet powder, the magnet powder is held for predetermined length of time within a temperature range between 200 and 900 degrees Celsius. Therefore, thermal decomposition of the organometallic compound can be caused reliably and carbon contained in the magnet powder can be removed more than required.

According to the manufacturing method of a permanent magnet of the present invention, it is made possible to manufacture a permanent magnet configured such that Cu, Al, Dy, Tb, V, Mo, Zr, Ta, Ti, W, or Nb contained in the organometallic compound can be efficiently concentrated in grain boundaries of the magnet. As a result, it becomes possible to improve the magnetic performance thereof. Furthermore, the additive amount of Cu, Al, Dy, Tb, V, Mo, Zr, Ta, Ti, W, or Nb can be made smaller than the conventional amount, so that decline in residual magnetic flux density can be inhibited. Further, by calcining the magnet including an organometallic compound in hydrogen atmosphere before sintering, carbon content contained in magnet particles can be reduced previously. Consequently, the entirety of the magnet can be sintered densely without making a gap between a main phase and a grain boundary phase in the sintered magnet, and decline of coercive force can be avoided. Further, considerable alpha iron does not separate out in the main phase of the sintered magnet and serious deterioration of magnetic properties can be avoided.

Further, since powdery magnet particles are calcined, thermal decomposition of the contained organometallic compound can be caused more easily in the entirety of the magnet particles in comparison with the case of calcining magnet particles already formed into a shape. In other words, carbon content in the calcined powder can be reduced more reliably.

According to the manufacturing method of a permanent magnet of the present invention, the organometallic compound consisting of an alkyl group is used as organometallic compound to be added to magnet powder. Therefore, thermal decomposition of the organometallic compound can be caused easily when the magnet powder is calcined in hydrogen atmosphere. Consequently, carbon content in the calcined powder can be reduced more reliably.

According to the manufacturing method of a permanent magnet of the present invention, the organometallic compound consisting of an alkyl group of which carbon number is any one of integer numbers 2 through 6 is used as organometallic compound to be added to magnet powder. Therefore, the organometallic compound can be thermally decomposed at low temperature when the magnet powder is calcined in hydrogen atmosphere. Consequently, thermal decomposition of the organometallic compound can be caused more easily in the entirety of the magnet powder. In other words, carbon content in the calcined powder can be reduced more reliably through a calcination process.

According to the manufacturing method of a permanent magnet of the present invention, in the step of calcining the magnet powder, the magnet powder is held for predetermined length of time within a temperature range between 200 and 900 degrees Celsius. Therefore, thermal decomposition of the organometallic compound can be caused reliably and carbon contained therein can be removed more than required.

### BRIEF DESCRIPTION OF THE DRAWINGS

FIG. 1 is an overall view of a permanent magnet directed to the invention.

FIG. 2 is an enlarged schematic view in vicinity of grain boundaries of the permanent magnet directed to the invention.

FIG. 3 is an enlarged schematic view in vicinity of grain boundaries of the permanent magnet directed to the invention.

FIG. 4 is an explanatory diagram illustrating manufacturing processes of a permanent magnet according to a first manufacturing method of the invention.

FIG. 5 is an explanatory diagram illustrating manufacturing processes of a permanent magnet according to a second manufacturing method of the invention.

FIG. 6 is a diagram illustrating changes of oxygen content with and without a calcination process in hydrogen.

FIG. 7 is a table illustrating residual carbon content in permanent magnets of embodiment 1, and comparative examples 1 and 2.

### BEST MODE FOR CARRYING OUT THE INVENTION

Specific embodiment of a permanent magnet and a method for manufacturing the permanent magnet according to the present invention will be described below in detail with reference to the drawings.

[Constitution of Permanent Magnet]

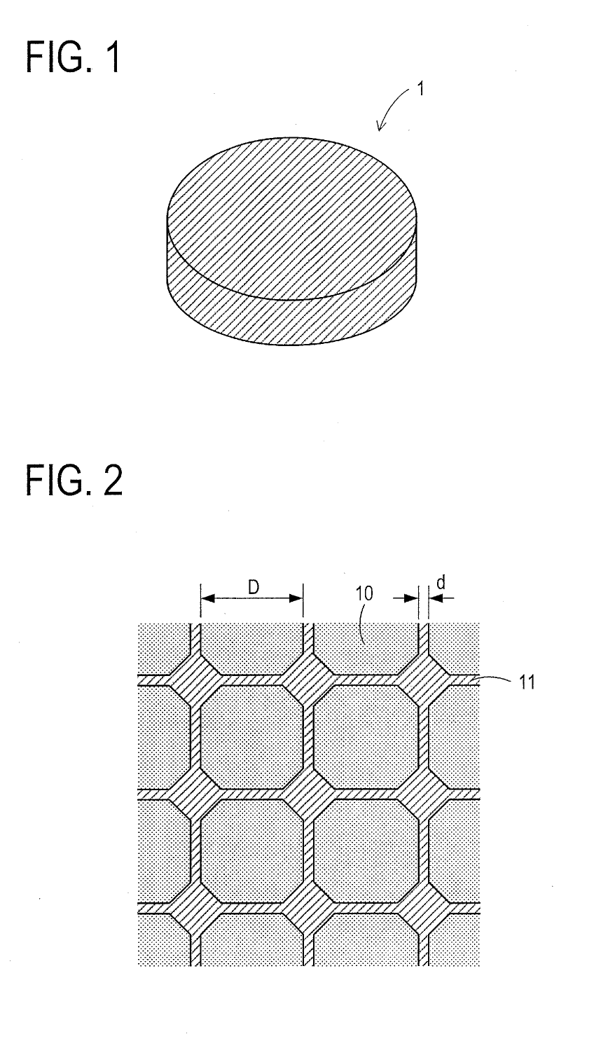

First, a constitution of a permanent magnet 1 will be described. FIG. 1 is an overall view of the permanent magnet directed to the present invention. Incidentally, the permanent magnet 1 depicted in FIG. 1 is formed into a cylindrical shape. However, the shape of the permanent magnet 1 may be changed in accordance with the shape of a cavity used for formation.

As the permanent magnet 1 according to the present invention, an Nd—Fe—B-based magnet may be used, for example. Further, on the boundary faces (grain boundaries) of Nd crystal grains forming the permanent magnet 1, there is concentrated Cu, Al, Dy (dysprosium), Tb (terbium), Nb (niobium), V (vanadium), Mo (molybdenum), Zr (zirconium), Ta (tantalum), Ti (titanium) or W (tungsten) for increasing the coercive force of the permanent magnet 1. Incidentally, the contents of respective components are regarded as Nd: 25 to 37 wt %, any one of Cu, Al, Dy, Tb, Nb, V, Mo, Zr, Ta, Ti and W (hereinafter referred to as “Nb (or other)”): 0.01 to 5 wt %, B: 0.8 to 2 wt %, and Fe (electrolytic iron): 60 to 75 wt %. Furthermore, the permanent magnet 1 may include other elements such as Co, or Si in small amount, in order to improve the magnetic properties thereof.

Specifically, in the permanent magnet 1 according to the present invention, Nb (or other) is concentrated onto the grain boundaries of the Nd crystal grains 10 by generating a layer 11 (hereinafter referred to as a metal concentration layer 11) in which Nb (or other) substitutes for part of Nd on each surface (outer shell) of the Nd crystal grains 10 constituting the permanent magnet 1 as depicted in FIG. 2. FIG. 2 is an enlarged view showing the Nd crystal grains 10 constituting the permanent magnet 1. The metal concentration layer 11 is preferably nonmagnetic.

Here, in the present invention, the substitution of Nb (or other) is carried out before the magnet powder is formed into a shape, through addition of an organometallic compound containing Nb (or other) milled as later described. Specifically, here, the organometallic compound containing the Nb (or other) is uniformly adhered to the surfaces of the Nd crystal grains 10 by wet dispersion and the Nb (or other) included in the organometallic compound diffusively intrudes into the crystal growth region of the Nd crystal grains 10 and substitutes for Nd, to form the metal concentration layers 11 shown in FIG. 2, when the magnet powder to which the organometallic compound containing Nb (or other) is added is sintered. Incidentally, the Nd crystal grain 10 may be composed of, for example, Nd₂Fe₁₄B intermetallic compound, and the metal concentration layer 11 may be composed of, for example, NbFeB intermetallic compound.

Furthermore, in the present invention, specifically as later described, the organometallic compound containing Nb (or other) is expressed by M-(OR)_{X} (in the formula, M represents Cu, Al, Dy, Tb, V, Mo, Zr, Ta, Ti, W or Nb, R represents a substituent group consisting of a straight-chain or branched-chain hydrocarbon and _{X} represents an arbitrary integer), and the organometallic compound containing Nb (or other) (such as niobium ethoxide, niobium n-propoxide, niobium n-butoxide, niobium n-hexoxide) is added to an organic solvent and mixed with the magnet powder in a wet condition. Thus, the organometallic compound containing Nb (or other) is dispersed in the organic solvent, enabling the organometallic compound containing Nb (or other) to be adhered onto the surfaces of Nd crystal grains 10 effectively.

Here, metal alkoxide is one of the organometallic compounds that satisfy the above structural formula M-(OR)_{X} (in the formula, M represents Cu, Al, Dy, Tb, V, Mo, Zr, Ta, Ti, W or Nb, R represents a substituent group consisting of a straight-chain or branched-chain hydrocarbon and _{X} represents an arbitrary integer). The metal alkoxide is expressed by a general formula M-(OR)ₙ (M: metal element, R: organic group, n: valence of metal or metalloid). Furthermore, examples of metal or metalloid composing the metal alkoxide include W, Mo, V, Nb, Ta, Ti, Zr, Ir, Fe, Co, Ni, Cu, Zn, Cd, Al, Ga, In, Ge, Sb, Y, lanthanide and the like. However, the present invention preferably uses Cu, Al, Dy, Tb, V, Mo, Zr, Ta, Ti, W or Nb, for the purpose of improving magnetic properties of the permanent magnet 1.

Furthermore, the types of the alkoxide are not specifically limited, and there may be used, for instance, methoxide, ethoxide, propoxide, isopropoxide, butoxide or alkoxide the carbon number of which is 4 or larger. However, in the present invention, those of low-molecule weight are used in order to inhibit the carbon residue by means of thermal decomposition at a low temperature to be later described. Furthermore, methoxide carbon number of which is 1 is prone to decompose and difficult to deal with, therefore it is preferable to use alkoxide carbon number of which is 2 through 6 included in R, such as ethoxide, methoxide, isopropoxide, propoxide or butoxide. That is, in the present invention, it is preferable to use, as the organometallic compound to be added to the magnet powder, an organometallic compound expressed by M-(OR), (in the formula, M represents Cu, Al, Dy, Tb, V, Mo, Zr, Ta, Ti, W or Nb, R represents a straight-chain or branched-chain alkyl group and ₓ represents an arbitrary integer) or it is more preferable to use an organometallic compound expressed by M-(OR)ₓ (in the formula, M represents Cu, Al, Dy, Tb, V, Mo, Zr, Ta, Ti, W or Nb, R represents a straight-chain or branched-chain alkyl group of which carbon number is 2 through 6, and ₓ represents an arbitrary integer).

Furthermore, a formed body produced through powder compaction can be sintered under appropriate sintering conditions so that Nb (or other) can be prevented from being diffused or penetrated (solid-solutionized) into the Nd crystal grains 10. Thus, in the present invention, even if Nb (or other) is added, Nb (or other) can be concentrated only within the grain boundaries after sintering. As a result, the phase of the Nd₂Fe₁₄B intermetallic compound of the core accounts for the large proportion in volume, with respect to crystal grains as a whole (in other words, the sintered magnet in its entirety). Accordingly, the decrease of the residual magnetic flux density (magnetic flux density at the time when the intensity of the external magnetic field is brought to zero) can be inhibited.

Further, generally, in a case where sintered Nd crystal grains 10 are densely aggregated, exchange interaction is presumably propagated among the Nd crystal grains 10. As a result, when a magnetic field is applied from outside, magnetization reversal easily takes place in the crystal grains, and coercive force thereof decreases even if sintered crystal grains can be made to have a single domain structure. However, in the present invention, there are provided metal concentration layers 11 which are nonmagnetic and coat the surfaces of the Nd crystal grains 10, and the metal concentration layers 11 disrupt the exchange interaction among the Nd crystal grains 10. Accordingly, magnetization reversal can be prevented in the crystal grains, even if a magnetic field is applied from outside.

Furthermore, if the metal concentration layers 11 are composed of a layer specifically including a refractory metal such as V, Mo, Zr, Ta, Ti, W or Nb, the metal concentration layers 11 coating the surfaces of the Nd crystal grains 10 may also function as a means of inhibiting what is called grain growth in which an average particle diameter increases in Nd crystal grains 10 at the sintering of the permanent magnet 1.

Meanwhile, if the metal concentration layers 11 are composed of a layer specifically including highly anisotropic Dy or Tb, the metal concentration layers 11 may also function as a means of preventing a reverse magnetic domain from generating, and improving coercive force (inhibiting magnetization reversal).

Furthermore, if the metal concentration layers 11 are composed of a layer specifically including Cu or Al, the metal concentration layers 11 may also function as a means of uniformly dispersing a Nd-rich phase in a permanent magnet 1 after sintering, and improving coercive force.

Furthermore, it is desirable that the particle diameter D of the Nd crystal grain 10 is from 0.2 μm to 1.2 μm, preferably approximately 0.3 μm. Also, a thickness d of approximately 2 nm is enough for the metal concentration layer 11 to obtain such effects by the metal concentration layer 11 as inhibition of grain growth, disruption of exchange interaction, and improvement of coercive force. However, if the thickness d of the metal concentration layer 11 excessively increases, the proportion of nonmagnetic components which exert no magnetic properties becomes large, so that the residual magnetic flux density becomes low.

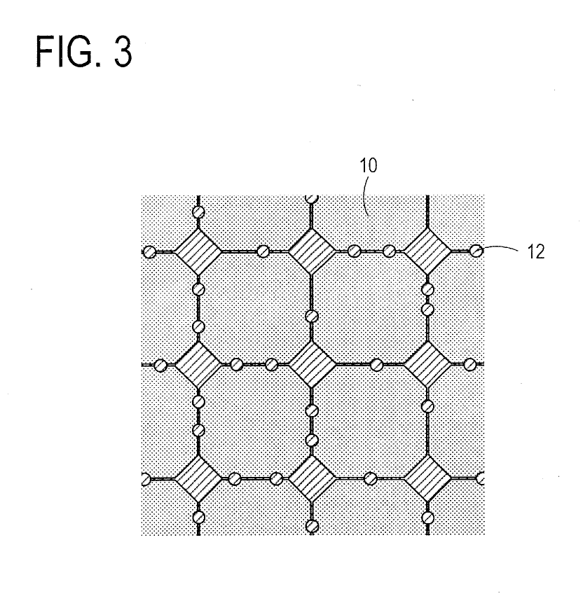

However, as a configuration for concentrating Nb (or other) on the grain boundaries of the Nd crystal grains 10, there may be employed a configuration in which agglomerates 12 composed of Nb (or other) are scattered onto the grain boundaries of the Nd crystal grains 10, as shown in FIG. 3. The similar effects such as inhibition of grain growth, disruption of exchange interaction, and improvement of coercive force can be obtained even in the configuration shown in FIG. 3. The concentration of Nb (or other) in the grain boundaries of the Nd crystal grains 10 can be confirmed through SEM, TEM or three-dimensional atom probe technique, for instance.

Incidentally, the metal concentration layer 11 is not restricted to be a layer composed of only any one of compounds including Cu compound, Al compound, Dy compound, Tb compound, Nb compound, V compound, Mo compound, Zr compound, Ta compound, Ti compound and W compound (hereinafter, any one of the above compounds is referred to as “Nb (or other) compound”), and may be a layer composed of a mixture of a Nb (or other) compound and a Nd compound. In such a case, the Nd compound is added to form a layer composed of the mixture of the Nb (or other) compound and the Nd compound. As a result, the liquid-phase sintering of the Nd magnet powder can be promoted at the time of sintering. The desirable Nd compound to be added may be NdH₂, neodymium acetate hydrate, neodymium(III) acetylacetonate trihydrate, neodymium(III) 2-ethylhexanoate, neodymium(III) hexafluoroacetylacetonate dihydrate, neodymium isopropoxide, neodymium(III) phosphate n-hydrate, neodymium trifluoroacetylacetonate, and neodymium trifluoromethanesulfonate or the like.

### [First Method for Manufacturing Permanent Magnet]

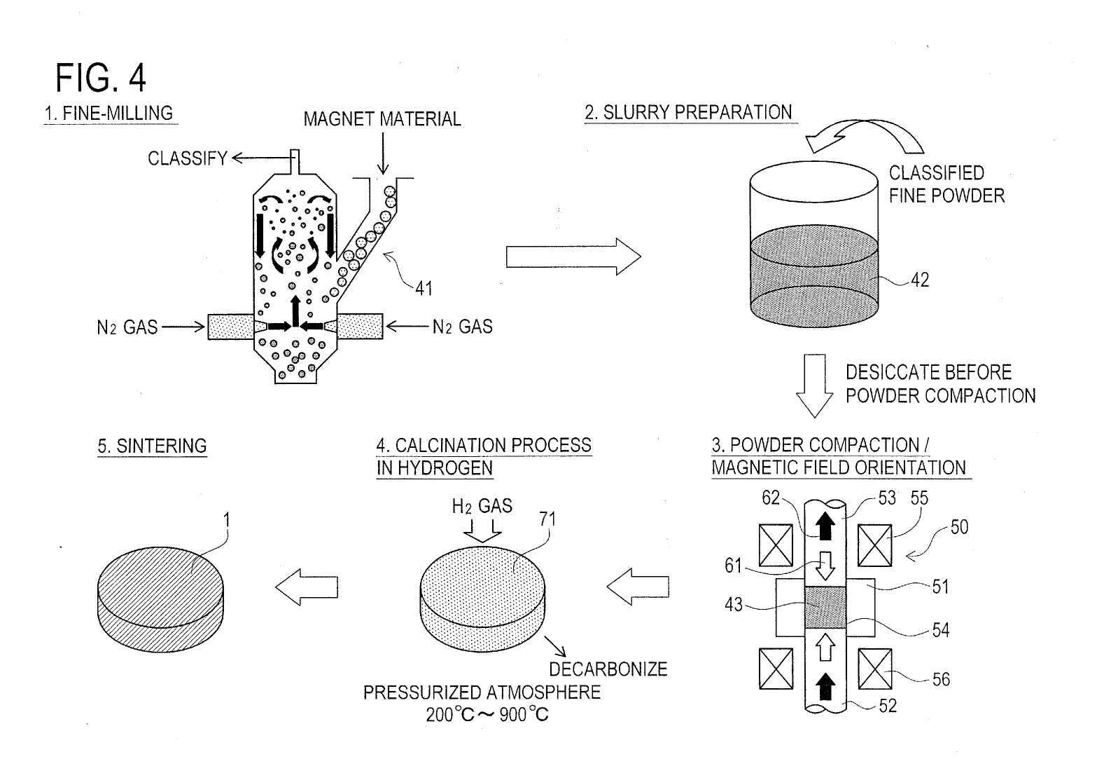

Next, the first method for manufacturing the permanent magnet 1 directed to the present invention will be described below with reference to FIG. 4. FIG. 4 is an explanatory view illustrating a manufacturing process in the first method for manufacturing the permanent magnet 1 directed to the present invention.

First, there is manufactured an ingot comprising Nd—Fe—B of certain fractions (for instance, Nd: 32.7 wt %, Fe (electrolytic iron): 65.96 wt %, and B: 1.34 wt %). Thereafter the ingot is coarsely milled using a stamp mill, a crusher, etc. to a size of approximately 200 μm. Otherwise, the ingot is melted, formed into flakes using a strip-casting process, and then coarsely powdered using a hydrogen pulverization method.

Next, the coarsely milled magnet powder is finely milled with a jet mill 41 to form fine powder of which the average particle diameter is smaller than a predetermined size (for instance, 0.1 μm through 5.0 μm) in: (a) an atmosphere composed of inert gas such as nitrogen gas, argon (Ar) gas, helium (He) gas or the like having an oxygen content of substantially 0%; or (b) an atmosphere composed of inert gas such as nitrogen gas, Ar gas, He gas or the like having an oxygen content of 0.0001 through 0.5%. Here, the term “having an oxygen content of substantially 0%” is not limited to a case where the oxygen content is completely 0%, but may include a case where oxygen is contained in such an amount as to allow a slight formation of an oxide film on the surface of the fine powder.

In the meantime, organometallic compound solution is prepared for adding to the fine powder finely milled by the jet mill 41. Here, an organometallic compound containing Nb (or other) is added in advance to the organometallic compound solution and dissolved therein. Incidentally, in the present invention, it is preferable to use, as the organometallic compound to be dissolved, an organometallic compound (such as niobium ethoxide, niobium n-propoxide, niobium n-butoxide or niobium n-hexoxide) pertinent to formula M-(OR)ₓ (in the formula, M represents Cu, Al, Dy, Tb, V, Mo, Zr, Ta, Ti, W or Nb, R represents a straight-chain or branched-chain alkyl group of which carbon number is 2 through 6 and ₓ represents an arbitrary integer). Furthermore, the amount of the organometallic compound containing Nb (or other) to be dissolved is not particularly limited, however, it is preferably adjusted to such an amount that the Nb (or other) content with respect to the sintered magnet is 0.001 wt % through 10 wt %, or more preferably, 0.01 wt % through 5 wt %, as above described.

Successively, the above organometallic compound solution is added to the fine powder classified with the jet mill 41. Through this, slurry 42 in which the fine powder of magnet raw material and the organometallic compound solution are mixed is prepared. Here, the addition of the organometallic compound solution is performed in an atmosphere composed of inert gas such as nitrogen gas, Ar gas or He gas.

Thereafter, the prepared slurry 42 is desiccated in advance through vacuum desiccation or the like before formed into a shape and desiccated magnet powder 43 is obtained. Then, the desiccated magnet powder is subjected to powder-compaction to form a given shape using a compaction device 50. There are dry and wet methods for the powder compaction, and the dry method involves filling a cavity with the desiccated fine powder and the wet method involves preparing slurry of the desiccated fine powder using solvent and then filling a cavity therewith. In this embodiment, a case where the dry method is used is described as an example. Furthermore, the organometallic compound solution can be volatilized at the sintering stage after compaction.

As illustrated in FIG. 4, the compaction device 50 has a cylindrical mold 51, a lower punch 52 and an upper punch 53, and a space surrounded therewith forms a cavity 54. The lower punch 52 slides upward/downward with respect to the mold 51, and the upper punch 53 slides upward/downward with respect to the mold 51, in a similar manner.

In the compaction device 50, a pair of magnetic field generating coils 55 and 56 is disposed in the upper and lower positions of the cavity 54 so as to apply magnetic flux to the magnet powder 43 filling the cavity 54. The magnetic field to be applied may be, for instance, 1 MA/m.

When performing the powder compaction, firstly, the cavity 54 is filled with the desiccated magnet powder 43. Thereafter, the lower punch 52 and the upper punch 53 are activated to apply pressure against the magnet powder 43 filling the cavity 54 in a pressure direction of arrow 61, thereby performing compaction thereof. Furthermore, simultaneously with the pressurization, pulsed magnetic field is applied to the magnet powder 43 filling the cavity 54, using the magnetic field generating coils 55 and 56, in a direction of arrow 62 which is parallel with the pressure direction. As a result, the magnetic field is oriented in a desired direction. Incidentally, it is necessary to determine the direction in which the magnetic field is oriented while taking into consideration the magnetic field orientation required for the permanent magnet 1 formed from the magnet powder 43.

Furthermore, in a case where the wet method is used, slurry may be injected while applying the magnetic field to the cavity 54, and in the course of the injection or after termination of the injection, a magnetic field stronger than the initial magnetic field may be applied while performing the wet molding. Furthermore, the magnetic field generating coils 55 and 56 may be disposed so that the application direction of the magnetic field is perpendicular to the pressure direction.

Furthermore, instead of the above-discussed powder compaction, green sheet molding may be employed to produce a formed body. There are several methods, for instance, for producing a formed body by the green sheet molding as shown below. The first method is as follows: mixing milled magnet powder, organic solvent and a binder resin, to obtain slurry, and coating a surface of a base with the slurry at a predetermined thickness using a coating method such as a doctor blade system, die casting or a comma coating system, to form a green sheet. The second method is as follows: mixing the magnet powder and the binder resin to obtain a powdery mixture, and, depositing the heated and melted powdery mixture onto a base to form a green sheet. In a case of using the first method for producing the green sheet, magnetic field is applied before the slurry on the base dries, for magnetic field orientation of the green sheet. Meanwhile, in a case of employing the second method for producing the green sheet, the once produced green sheet is heated and magnetic field is applied to the heated green sheet, for magnetic field orientation.

Secondly, the formed body 71 produced through the powder compaction is held for several hours (for instance, five hours) at 200 through 900 degrees Celsius, or more preferably 400 through 900 degrees Celsius (for instance, 600 degrees Celsius) in hydrogen atmosphere at a pressure higher than normal atmospheric pressure (for instance, 0.5 MPa or 1.0 MPa), to perform a calcination process in hydrogen. The hydrogen feed rate during the calcination is 5 L/min. So-called decarbonization is performed during this calcination process in hydrogen. In the decarbonization, the organometallic compound is thermally decomposed so that carbon content in the calcined body can be decreased. Furthermore, calcination process in hydrogen is to be performed under a condition that makes carbon content in the calcined body 1000 ppm or lower, or more preferably 600 ppm or lower. Accordingly, it becomes possible to densely sinter the permanent magnet 1 as a whole in the later sintering process, and the decrease in the residual magnetic flux density and coercive force can be prevented.

Here, NdH₃ exists in the formed body 71 calcined through the calcination process in hydrogen as above described, and this indicates a problematic tendency to combine with oxygen. However, in the first manufacturing method, the formed body 71 after the calcination is brought to the later-described sintering without being exposed to the external air, eliminating the need for the dehydrogenation process. The hydrogen contained in the formed body is removed while being sintered. As pressurization condition for above-described calcination process in hydrogen, a pressure higher than normal atmospheric pressure is optimal; however, 15 MPa or lower is desirable.

Following the above, there is performed a sintering process for sintering the formed body 71 calcined through the calcination process in hydrogen. However, for a sintering method for the formed body 71, there can be employed, besides commonly-used vacuum sintering, pressure sintering in which the formed body 71 is sintered in a pressured state. For instance, when the sintering is performed in the vacuum sintering, the temperature is raised to approximately 800 through 1080 degrees Celsius in a given rate of temperature increase and held for approximately two hours. During this period, the vacuum sintering is performed, and as to the degree of vacuum, the pressure is preferably equal to or lower than 5 Pa, or more preferably equal to or lower than 10⁻² Pa. The formed body 71 is then cooled down, and again undergoes a heat treatment in 600 through 1000 degrees Celsius for two hours. As a result of the sintering, the permanent magnet 1 is manufactured.

Meanwhile, the pressure sintering includes, for instance, hot pressing, hot isostatic pressing (HIP), high pressure synthesis, gas pressure sintering, and spark plasma sintering (SPS) and the like. However, it is preferable to adopt the spark plasma sintering so as to prevent grain growth of the magnet particles during the sintering and also to prevent a warp from occurring in the sintered magnets. The spark plasma sintering is uniaxial pressure sintering in which pressure is uniaxially applied and also in which sintering is performed by electric current sintering. Incidentally, the following are the preferable conditions when the sintering is performed in the SPS; pressure is applied at 30 MPa, the temperature is raised at a rate of 10 degrees Celsius per minute until reaching 940 degrees Celsius in vacuum atmosphere of several Pa or less and then the state of 940 degrees Celsius in vacuum atmosphere is held for approximately five minutes. The formed body 71 is then cooled down, and again undergoes a heat treatment in 600 through 1000 degrees Celsius for two hours. As a result of the sintering, the permanent magnet 1 is manufactured.

### [Second Method for Manufacturing Permanent Magnet]

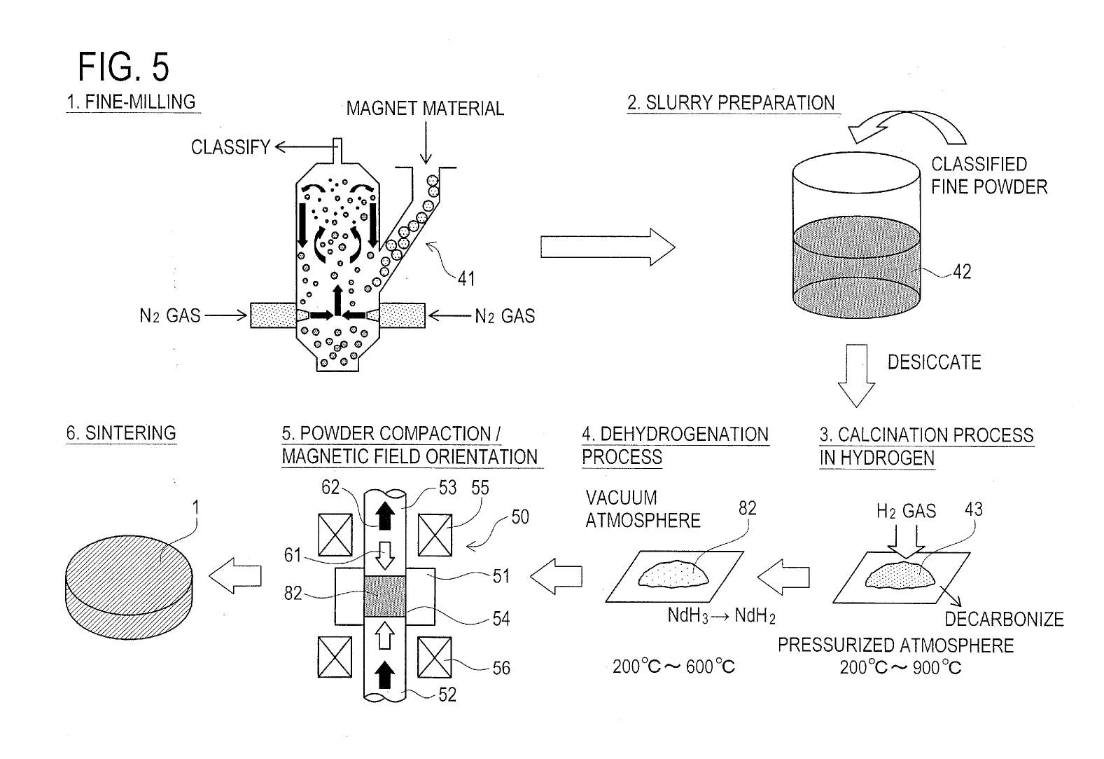

Next, the second method for manufacturing the permanent magnet 1 which is an alternative manufacturing method will be described below with reference to FIG. 5. FIG. 5 is an explanatory view illustrating a manufacturing process in the second method for manufacturing the permanent magnet 1 directed to the present invention.

The process until the slurry 42 is manufactured is the same as the manufacturing process in the first manufacturing method already discussed referring to FIG. 4, therefore detailed explanation thereof is omitted.

Firstly, the prepared slurry 42 is desiccated in advance through vacuum desiccation or the like before formed into a shape, and desiccated magnet powder 43 is obtained. Then, the desiccated magnet powder 43 is held for several hours (for instance, five hours) at 200 through 900 degrees Celsius, or more preferably 400 through 900 degrees Celsius (for instance, 600 degrees Celsius) in hydrogen atmosphere at a pressure higher than normal atmospheric pressure (for instance, 0.5 MPa or 1.0 MPa), for a calcination process in hydrogen. The hydrogen feed rate during the calcination is 5 L/min. Decarbonization is performed in this calcination process in hydrogen. In the decarbonization, the organometallic compound is thermally decomposed so that carbon content in the calcined powder can be decreased. Furthermore, calcination process in hydrogen is to be performed under a condition that makes carbon content in the calcined powder 1000 ppm or lower, or more preferably 600 ppm or lower. Accordingly, it becomes possible to densely sinter the permanent magnet 1 as a whole in the later sintering process, and the decrease in the residual magnetic flux density and coercive force can be prevented.

Secondly, the calcined powder 82 in a powdery state calcined through the calcination process in hydrogen is held for one through three hours in vacuum atmosphere at 200 through 600 degrees Celsius, or more preferably 400 through 600 degrees Celsius for a dehydrogenation process. Incidentally, as to the degree of vacuum, the pressure is preferably equal to or lower than 0.1 Torr.

Here, NdH₃ exists in the calcined powder 82 calcined through the calcination process in hydrogen as above described, which indicates a problematic tendency to combine with oxygen.

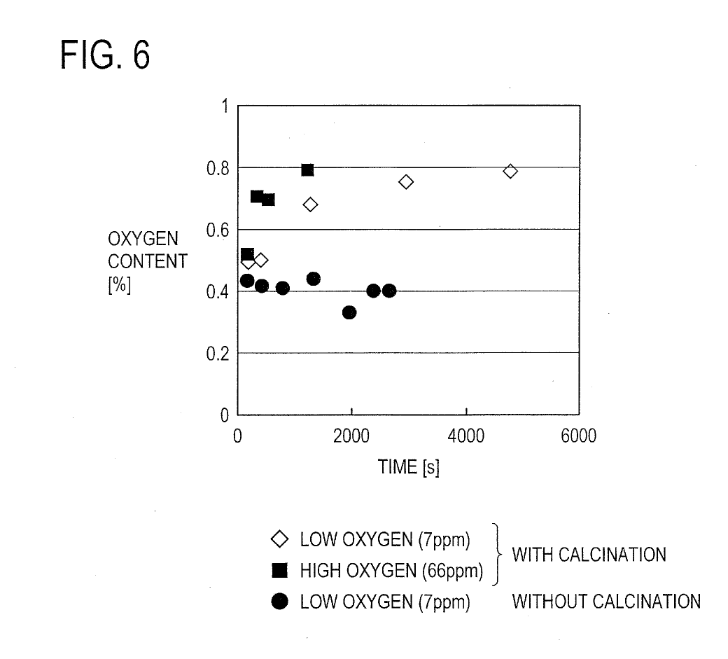

FIG. 6 is a diagram depicting oxygen content of magnet powder with respect to exposure duration, when Nd magnet powder with a calcination process in hydrogen and Nd magnet powder without a calcination process in hydrogen are exposed to each of the atmosphere with oxygen concentration of 7 ppm and the atmosphere with oxygen concentration of 66 ppm. As illustrated in FIG. 6, when the Nd magnet powder with the calcination process in hydrogen is exposed to the atmosphere with high-oxygen concentration of 66 ppm, the oxygen content of the magnet powder increases from 0.4% to 0.8% in approximately 1000 sec. Even when the Nd magnet powder with the calcination process is exposed to the atmosphere with low-oxygen concentration of 7 ppm, the oxygen content of the magnet powder still increases from 0.4% to the similar amount 0.8%, in approximately 5000 sec. Oxygen combined with Nd magnet particles causes the decrease in the residual magnetic flux density and in the coercive force.

Therefore, in the above dehydrogenation process, NdH₃ (having high reactivity level) in the calcined powder 82 created at the calcination process in hydrogen is gradually changed: from NdH₃ (having high reactivity level) to NdH₂ (having low reactivity level). As a result, the reactivity level is decreased with respect to the calcined powder 82 activated by the calcination process in hydrogen. Accordingly, if the calcined powder 82 calcined at the calcination process in hydrogen is later moved into the external air, Nd magnet particles therein are prevented from combining with oxygen, and the decrease in the residual magnetic flux density and coercive force can also be prevented.

Then, the calcined powder 82 in a powdery state after the dehydrogenation process undergoes the powder compaction to be compressed into a given shape using the compaction device 50. Details are omitted with respect to the compaction device 50 because the manufacturing process here is similar to that of the first manufacturing method already described referring to FIG. 4.

Then, there is performed a sintering process for sintering the formed-state calcined powder 82. The sintering process is performed by the vacuum sintering or the pressure sintering similar to the above first manufacturing method. Details of the sintering condition are omitted because the manufacturing process here is similar to that of the first manufacturing method already described. As a result of the sintering, the permanent magnet 1 is manufactured.

However, the second manufacturing method discussed above has an advantage that the calcination process in hydrogen is performed to the powdery magnet particles, therefore the thermal decomposition of the organometallic compound can be more easily caused to the whole magnet particles, in comparison with the first manufacturing method in which the calcination process in hydrogen is performed to the magnet particles of the formed state. That is, it becomes possible to securely decrease the carbon content of the calcined powder, in comparison with the first manufacturing method.

However, in the first manufacturing method, the formed body 71 after calcined in hydrogen is brought to the sintering without being exposed to the external air, eliminating a need for a dehydrogenation process. Accordingly, the manufacturing process can be simplified in comparison with the second manufacturing method. However, also in the second manufacturing method, the dehydrogenation process becomes unnecessary in a case where the sintering is performed without any exposure to the external air after calcined in hydrogen.

### EMBODIMENT

Here will be described an embodiment according to the present invention referring to comparative examples for comparison.

### Embodiment 1

In comparison with a fraction regarding alloy composition of a neodymium magnet according to the stoichiometric composition (Nd: 26.7 wt %, Fe (electrolytic iron): 72.3 wt %, B: 1.0 wt %), proportion of Nd in that of the neodymium magnet powder for the embodiment 1 is set higher, such as Nd/Fe/B=32.7/65.96/1.34 in wt %, for instance. Further, 5 wt % of niobium n-propoxide has been added as organometallic compound to the milled neodymium magnet powder. A calcination process has been performed by holding the magnet powder before formed into a shape for five hours at 600 degrees Celsius in hydrogen atmosphere at 0.5 MPa being a pressure higher than normal atmospheric pressure (in this embodiment, the normal atmospheric pressure at manufacturing is assumed to be standard atmospheric pressure (approx. 0.1 MPa)). The hydrogen feed rate during the calcination is 5 L/min. Sintering of the formed-state calcined powder has been performed in a vacuum atmosphere. Other processes are the same as the processes in [Second Method for Manufacturing Permanent Magnet] mentioned above.

### Comparative Example 1

Niobium n-propoxide has been used as organometallic compound to be added. The calcination process in hydrogen has been performed under hydrogen atmosphere of normal atmospheric pressure (0.1 MPa). Other conditions are the same as the conditions in embodiment 1.

### Comparative Example 2

Niobium ethoxide has been used as organometallic compound to be added, and sintering has been performed without undergoing a calcination process in hydrogen. Other conditions are the same as the conditions in embodiment 1.

(Comparison of Embodiment with Comparative Examples Regarding Residual Carbon Content)

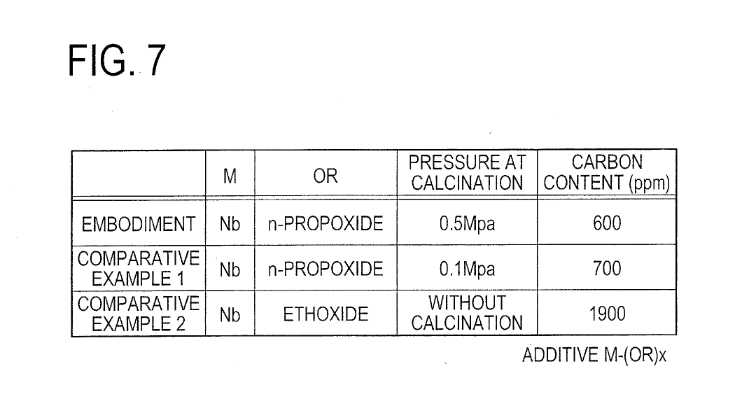

The table of FIG. 7 shows residual carbon content [ppm] in permanent magnets according to embodiment 1 and comparative examples 1 and 2, respectively.

As shown in FIG. 7, comparison of embodiment 1 and comparative examples 1 and 2 shows that the carbon content remaining in the magnet particles can be made significantly smaller when the calcination process in hydrogen has been performed, than in the case without the calcination process in hydrogen. Specifically in embodiment 1, the carbon content remaining in the magnet particles can be made 600 ppm or lower. This demonstrates that the calcination process in hydrogen enables the decarbonization in which carbon content in the calcined powder is decreased through thermally decomposing the organometallic compound. As a result of that, it becomes possible to densely sinter the entirety of the magnet and to prevent deterioration of the coercive force.

Further, as it is apparent from a comparison between the embodiment 1 and the comparative example 1, despite addition of the same organometallic compound, the case with the calcination process in hydrogen at a pressure higher than normal atmospheric pressure can reduce carbon content more significantly than the case at normal atmospheric pressure. In other words, through the calcination process in hydrogen, there can be performed the decarbonization, in which the organometallic compound is thermally decomposed so that carbon content in the calcined powder can be decreased, and also, the calcination process in hydrogen at a pressure higher than normal atmospheric pressure can facilitate easier decarbonization. As a result, it becomes possible to densely sinter the entirety of the magnet and to prevent the coercive force from declining.

In the above embodiment 1 and comparative examples 1 and 2, permanent magnets manufactured basically in accordance with [Second Method for Manufacturing Permanent Magnet] have been used. Similar results can be obtained in cases of using permanent magnets manufactured basically in accordance with [First Method for Manufacturing Permanent Magnet].

As described in the above, with respect to the permanent magnet 1 and the manufacturing method of the permanent magnet 1 directed to the above embodiment, an organometallic compound solution is added to the fine powder of milled neodymium magnet material so as to uniformly adhere the organometallic compound to particle surfaces of the neodymium magnet powder, the organometallic compound being expressed with a structural formula of M-(OR)_{X} (wherein M represents Cu, Al, Dy, Tb, V, Mo, Zr, Ta, Ti, W or Nb, R represents a substituent group consisting of a straight-chain or branched-chain hydrocarbon and _{X} represents an arbitrary integer). Thereafter, a formed body produced through powder compaction is held for several hours in hydrogen atmosphere at a pressure higher than normal atmospheric pressure at 200 through 900 degrees Celsius for a calcination process in hydrogen. Thereafter, through vacuum sintering or pressure sintering, the permanent magnet 1 is manufactured. Owing to the above processes, even if Nb (or other) is added in a smaller amount than a conventional amount, the Nb (or other) added thereto can be efficiently concentrated in grain boundaries of the magnet. Consequently, it becomes possible to improve the magnetic performance of the permanent magnet 1. Further, decarbonization is made easier when adding the above specified organometallic compound to magnet powder in comparison with when adding other organometallic compounds. Furthermore, such sufficient decarbonization can prevent decline in coercive force which is likely to be caused by carbon contained in the sintered magnet. Furthermore, owing to such sufficient decarbonization, the entirety of the magnet can be sintered densely.

Still further, when V, Mo, Zr, Ta, Ti, W or Nb being refractory metal is concentrated in grain boundaries of the sintered magnet, V, Mo, Zr, Ta, Ti, W or Nb concentrated in the grain boundaries inhibits grain growth in the magnet particles at sintering, and at the same time disrupts exchange interaction among the magnet particles after sintering so as to prevent magnetization reversal in the magnet particles, making it possible to improve the magnetic performance thereof.

Still further, when Dy or Tb having high magnetic anisotropy is concentrated in grain boundaries of the sintered magnet, coercive force can be improved by Dy or Tb concentrated in the grain boundaries, preventing a reverse magnetic domain from generating in the grain boundaries.

Further, when Cu or Al is concentrated in the grain boundaries of a magnet, the Nd-rich phase can be dispersed uniformly and improvement of coercive force can be realized.

Still further, the magnet to which organometallic compound has been added is calcined in hydrogen atmosphere at a pressure higher than normal atmospheric pressure before sintering, so that the organometallic compound is thermally decomposed and carbon contained therein can be removed (carbon content can be reduced) in advance. Therefore, almost no carbide is formed in a sintering process. Consequently, the entirety of the magnet can be sintered densely without making a gap between a main phase and a grain boundary phase in the sintered magnet and decline of coercive force can be avoided. Further, considerable alpha iron does not separate out in the main phase of the sintered magnet and serious deterioration of magnetic properties can be avoided.

Still further, as typical organometallic compound to be added to magnet powder, it is preferable to use an organometallic compound consisting of an alkyl group, more preferably an alkyl group of which carbon number is any one of integer numbers 2 through 6. By using such configured organometallic compound, the organometallic compound can be thermally decomposed easily at a low temperature when the magnet powder or the formed body is calcined in hydrogen atmosphere. Thereby, the organometallic compound in the entirety of the magnet powder or the formed body can be thermally decomposed more easily.

Still further, in the process of calcining the magnet powder of the formed body, the formed body is held for predetermined length of time within a temperature range between 200 and 900 degrees Celsius, or more preferably, between 400 and 900 degrees Celsius. Therefore, carbon contained therein can be removed more than required.

As a result, carbon content remaining after sintering is 600 ppm or lower. Thereby, the entirety of the magnet can be sintered densely without occurrence of a gap between a main phase and a grain boundary phase and decline in residual magnetic flux density can be avoided. Further, this configuration prevents considerable alpha iron from separating out in the main phase of the sintered magnet so that serious deterioration of magnetic characteristics can be avoided.

In the second manufacturing method, calcination process is performed to the powdery magnet particles, therefore the thermal decomposition of the organometallic compound can be more easily performed to the whole magnet particles in comparison with a case of calcining magnet particles of formed state. That is, it becomes possible to reliably decrease the carbon content of the calcined powder. By performing dehydrogenation process after calcination process, reactivity level is decreased with respect to the calcined powder activated by the calcination process. Thereby, the resultant magnet particles are prevented from combining with oxygen and the decrease in the residual magnetic flux density and coercive force can also be prevented.

Still further, the dehydrogenation process is performed in such manner that the magnet powder is held for predetermined length of time within a range between 200 and 600 degrees Celsius. Therefore, even if NdH₃ having high reactivity level is produced in a Nd-based magnet that has undergone calcination process in hydrogen, all the produced NdH₃ can be changed to NdH₂ having low reactivity level.

It is to be understood that the present invention is not limited to the above-described embodiment but may be variously improved and modified without departing from the scope of the present invention.

Further, of magnet powder, milling condition, mixing condition, calcination condition, dehydrogenation condition, sintering condition, etc. are not restricted to conditions described in the embodiment. For instance, in the above embodiment, the calcination process is performed under hydrogen atmosphere pressurized to 0.5 MPa; however, the pressure can be set at a different value as long as it is higher than normal atmospheric pressure. Further, in the embodiment, sintering is performed by vacuum sintering. However, pressure sintering such as SPS may be employed.

Further, in the embodiment, niobium ethoxide, niobium n-propoxide, niobium n-butoxide or niobium n-hexoxide is used as organometallic compound containing Nb (or other) that is to be added to magnet powder. Other organometallic compounds may be used as long as being an organometallic compound that satisfies a formula of M-(OR)_{X} (M represents Cu, Al, Dy, Tb, V, Mo, Zr, Ta, Ti, W or Nb, R represents a substituent group consisting of a straight-chain or branched-chain hydrocarbon, and _{X} represents an arbitrary integer). For instance, there may be used an organometallic compound of which carbon number is 7 or larger and an organometallic compound including a substituent group consisting of carbon hydride other than an alkyl group. Elements (such as Nd or Ag) other than those metallic elements referred to in the above may be included as M in the formula.

### EXPLANATION OF REFERENCES

1 permanent magnet
10 Nd crystal grain
11 metal concentration layer
42 slurry
43 magnet powder
71 formed body
82 calcined powder

1. A permanent magnet manufactured through steps of:
milling magnet material into magnet powder;
adding an organometallic compound expressed with a structural formula of
M-(OR)_{X},
M representing Cu, Al, Dy, Tb, V, Mo, Zr, Ta, Ti, W or Nb, R representing a substituent group consisting of a straight-chain or branched-chain hydrocarbon, and _{X} representing an arbitrary integer,
to the magnet powder obtained at the step of milling magnet material and getting the organometallic compound adhered to particle surfaces of the magnet powder;
calcining the magnet powder of which particle surfaces have got adhesion of the organometallic compound in hydrogen atmosphere at a pressure higher than normal atmospheric pressure so as to obtain a calcined powder;
forming the calcined powder into a formed body; and
sintering the formed body.

2. The permanent magnet according to claim 1, wherein metal contained in the organometallic compound is concentrated in grain boundaries of the permanent magnet after sintering.

3. The permanent magnet according to claim 1, wherein R in the structural formula is an alkyl group.

4. The permanent magnet according to claim 3, wherein R in the structural formula is an alkyl group of which carbon number is any one of integer numbers 2 through 6.

5. The permanent magnet according to claim 1, wherein residual carbon content after sintering is 600 ppm or lower.

6. The permanent magnet according to claim 1, wherein, in the step of calcining the magnet powder, the magnet powder is held for predetermined length of time within a temperature range between 200 and 900 degrees Celsius.

7. A manufacturing method of a permanent magnet comprising steps of:
milling magnet material into magnet powder;
adding an organometallic compound expressed with a structural formula of
M-(OR)_{X},
M representing Cu, Al, Dy, Tb, V, Mo, Zr, Ta, Ti, W or Nb, R representing a substituent group consisting of a straight-chain or branched-chain hydrocarbon, and _{X} representing an arbitrary integer,
to the magnet powder obtained at the step of milling magnet material and getting the organometallic compound adhered to particle surfaces of the magnet powder;
calcining the magnet powder of which particle surfaces have got adhesion of the organometallic compound in hydrogen atmosphere at a pressure higher than normal atmospheric pressure so as to obtain calcined powder;
forming the calcined powder into a formed body; and
sintering the formed body.

8. The manufacturing method of a permanent magnet according to claim 7,
wherein R in the structural formula is an alkyl group.

9. The manufacturing method of a permanent magnet according to claim 8,
wherein R in the structural formula is an alkyl group of which carbon number is any one of integer numbers 2 through 6.

10. The manufacturing method of a permanent magnet according to claim 7, wherein, in the step of calcining the magnet powder, the magnet powder is held for predetermined length of time within a temperature range between 200 and 900 degrees Celsius.
